(19) United States
(12) Patent Application Publication
(10) Pub. No.: US 2026/0065097 A1
(43) Pub. Date: Mar. 5, 2026

(54) DATA PROCESSING METHOD AND DEVICE

(71) Applicant: Lenovo (Beijing) Limited, Beijing (CN)

(72) Inventors: Hai YU, Beijing (CN); Jing WU, Beijing (CN); Xuan WANG, Beijing (CN)

(21) Appl. No.: 19/312,614

(22) Filed: Aug. 28, 2025

(30) Foreign Application Priority Data
Aug. 29, 2024 (CN) 202411204981.1

(51) Int. Cl. G06N 5/04

(52) U.S. Cl. CPC G06N 5/04

(57) ABSTRACT

A data processing method includes processing first input data into second input data in response to obtaining a first processing instruction for the first input data, the first input data being data input to a target application; generating third input data based on an obtained adjustment operation for the second input data; and generating a target file matching a user intent based on the user intent represented by the third input data.

### CROSS-REFERENCES TO RELATED APPLICATION

This application claims priority to Chinese Patent Application No. 202411204981.1 filed on Aug. 29, 2024, the entire content of which is incorporated herein by reference.

### FIELD OF TECHNOLOGY

The present disclosure relates to the field of artificial intelligence (“AI”) technology and, more specifically, to a data processing method and device.

### BACKGROUND

With the development of artificial intelligence technology, artificial intelligence models have also been widely used in fields such as text recognition and image processing. However, the current artificial intelligence models have high prerequisites for users. Non-professional users who do not have certain professional knowledge find it difficult to use artificial intelligence models to generate accurate content, resulting in a poor user experience.

### SUMMARY

One aspect of this disclosure provides a data processing method. The method includes processing first input data into second input data in response to obtaining a first processing instruction for the first input data, the first input data being data input to a target application; generating third input data based on an obtained adjustment operation for the second input data; and generating a target file matching a user intent based on the user intent represented by the third input data.

Another aspect of this disclosure provides a data processing device. The device includes a processing module, a first generation module and a second generation. The processing module is configured to process first input data into second input data in response to obtaining a first processing instruction for the first input data, the first input data being data input to a target application. The first generation module is configured to generate third input data based on an obtained adjustment operation for the second input data. The second generation module is configured to generate a target file matching a user intent based on the user intent represented by the third input data.

Another aspect of this disclosure provides an electronic device. The electronic device includes one or more processors and one or more memories coupled to the one or more processors and storing a plurality of computer instructions that, when being executed, cause the one or more processors to process first input data into second input data in response to obtaining a first processing instruction for the first input data by using an AI processing model or an AI model service corresponding to the first processing instruction, the first input data being data input to a target application; generate third input data based on an obtained adjustment operation for the second input data, and generate a target file matching a user intent based on the user intent represented by the third input data.

### BRIEF DESCRIPTION OF THE DRAWINGS

To more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 is a flowchart of a data processing method according to some embodiments of the present disclosure.

FIG. 2 shows a user interface of an image generation application according to some embodiments of the present disclosure.

FIG. 3 shows another user interface of the image generation application according to some embodiments of the present disclosure.

FIG. 4 shows another user interface of the image generation application according to some embodiments of the present disclosure.

FIG. 5 shows another user interface of the image generation application according to some embodiments of the present disclosure.

FIG. 6 shows another user interface of the image generation application according to some embodiments of the present disclosure.

FIG. 7 is a schematic structural diagram of a data processing device according to some embodiments of the present disclosure.

FIG. 8 is a schematic structural diagram of an electronic device according to some embodiments of the present disclosure.

### DETAILED DESCRIPTION

Technical solutions of the present disclosure will be described in detail with reference to the drawings. It will be appreciated that the embodiments described represent some, rather than all, of the embodiments of the present disclosure. Other embodiments conceived or derived by those having ordinary skills in the art based on the described embodiments without inventive efforts should fall within the scope of the present disclosure.

Due to the high prerequisite of artificial intelligence models on users, it is difficult for non-professional users who do not have certain professional knowledge to use artificial intelligence models to generate accurate content, resulting in poor user experience. Therefore, in order to improve the user experience, embodiments of the present disclosure provide a data processing method and a data processing device. The electronic device provided in the present disclosure can be a mobile phone, a computer, a tablet computer and other devices. The data processing method provided in the present disclosure can be applied in scenarios including text generation, text analysis, image generation, image processing, video generation, and video analysis.

The technical solutions of the embodiments of the present disclosure will be described below in conjunction with the accompanying drawings provided in the present disclosure.

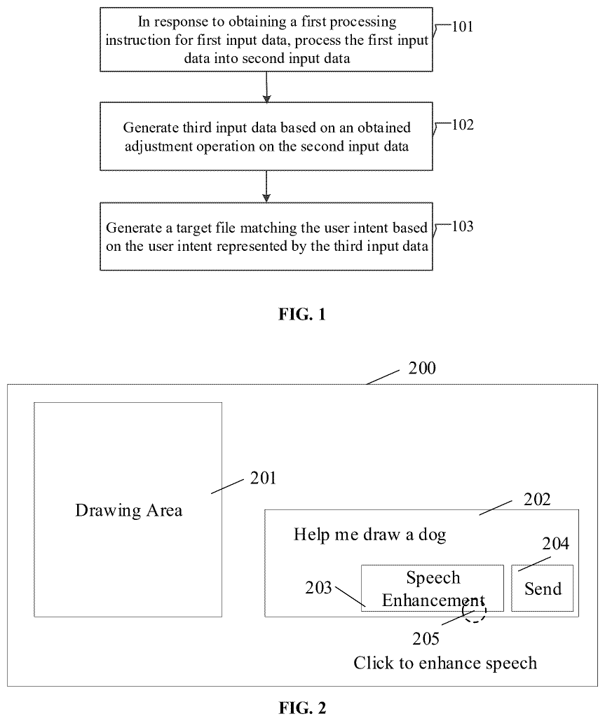

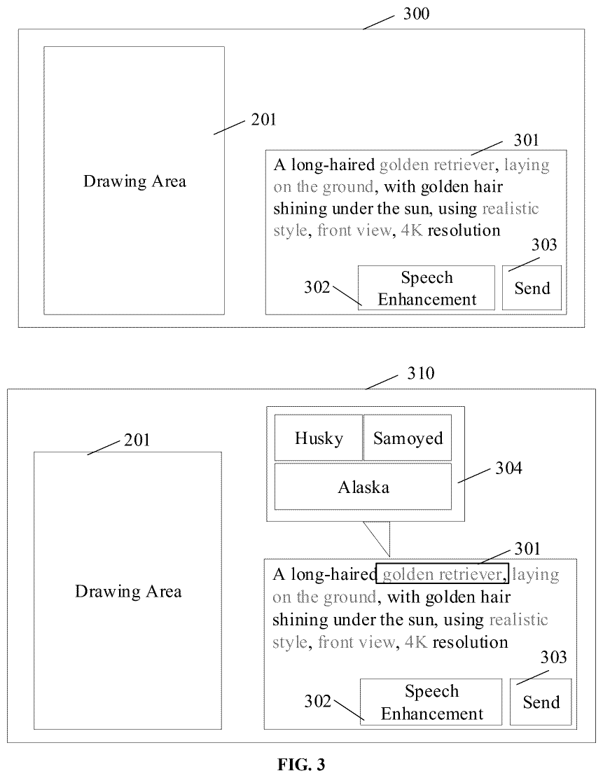

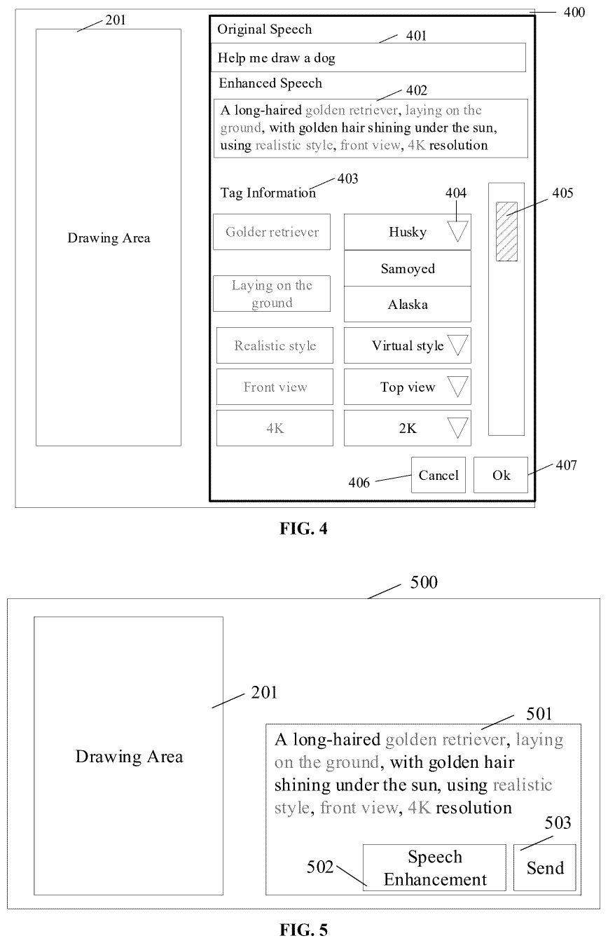

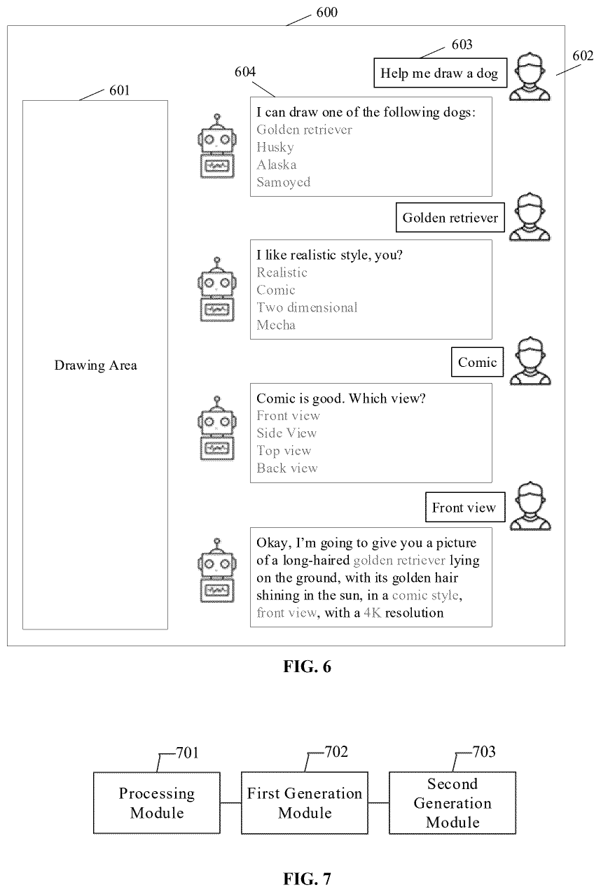

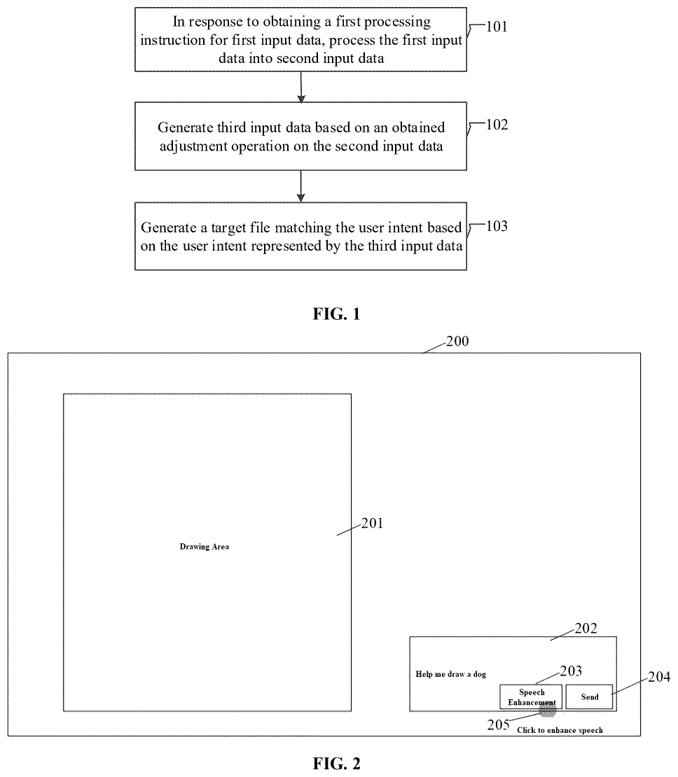

FIG. 1 is a flowchart of a data processing method according to some embodiments of the present disclosure. The method will be described in detail below.

101, in response to obtaining a first processing instruction for first input data, processing the first input data into second input data.

The first input data is data input to a target application. In the present disclosure, the target application may include an image generation application (such as Lenovo's creator zone), a text generation application, a video generation application, or an intelligent agent application (such as Lenovo's AI agent Xiaotian/AI Now). The intelligent agent application may be an intelligent assistant based on artificial intelligence technology, such as an intelligent voice assistant, a device intelligent assistant, etc. The target application may also include an application that can call or integrate an image generation application, a text generation application, a video generation application, and/or an intelligent agent application, such as a social media application or a photo album application. These applications can process input data by calling image generation applications, text generation applications, video generation applications and/or intelligent agent applications, or these applications can process input data through built-in large models (such as image generation models, text generation models, video generation models, audio generation models, UI generation models, etc.). For example, the target application is a social media application, which has a built-in text generation model and image generation model to support the generation of articles and/or images. The user can choose to create articles in the social media application by providing keywords or scene description information. The text generation model can generate text that meets the user's intention by identifying and extracting the features of keywords or scene description information. The image generation model can generate images that meet the user's intentions by identifying and extracting features of keywords or scene description information, and combine text and images to generate articles that meet the user's intentions.

In some embodiments, the first input data may include string data, multimedia data, and voice data. String data may include text and numbers, and multimedia data include images and videos.

In some embodiments, based on the first processing instruction, the first input data can be processed into the second input data. The first input data can be processed into the second input data in a corresponding processing manner based on the actual application scenario and the type of the first input data provided by the user. For example, the first input data may be processed using a text generation model, a picture-to-text conversion model, a speech-to-text model, an image generation model, or an audio generation model to obtain the second input data. For example, in the image generation application scenario, if the first input data is text data describing the features of a to-be-generated image, the first processing instruction can be an instruction to instruct the image generation model to expand the prompt words of the first input data, and the first input data can be processed by expanding the prompt words through the image generation model to obtain the second input data.

In some embodiments, the first processing instruction may be an instruction to expand the prompt words of the first input data, or an instruction to perform format conversion processing on the input data. For example, if the first input data is image data, the first processing instruction may be an instruction for converting the image data into text data for processing the first input data into second input data in text format. For example, in the application scenario of image generation, the first input data may be text data describing the features of the to-be-generated image. In order to make the generated image more accurate, the features of the to-be-generated image may be enhanced by providing prompt words to the user, and the first processing instruction may be an instruction to expand the prompt words to enhance the features of the to-be-generated image. For example, if the first input data is the text data of “generate an image of a puppy” provided by the user, the features of the to-be-generated image can be obtained based on the text data “generate an image of a puppy” including the generated object “puppy”. However, this feature is relatively broad and difficult to accurately reflect user's intention. In this case, the first processing instruction can be an instruction to expand the prompt words for the text data “generate an image of a puppy”, and the prompt words that can be expanded include but are not limited to prompt words representing the type of puppy, prompt words representing the color of the puppy, and prompt words representing the scene where the puppy is located. In another example, if the first input data is voice data of “generate an image of a puppy” provided by the user, the corresponding first processing instruction may be only to convert the voice data into the text data “generate an image of a puppy”, or may include an instruction to expand the prompt words of the text data “generate an image of a puppy”. In another example, if the first input data is an image of a cat provided by the user, the first processing instruction in the present disclosure may include an instruction to extract text data representing features of the image, such as extracting the text data “a kitten playing”, and performing prompt words expansion on the text data “a kitten playing”. The prompt words that can be expanded include, but are not limited to, prompt words that characterize the type of kittens, prompt words that characterize the color of kittens, prompt words that characterize the number of kittens, and prompt words that characterize the scene in which the kittens are located.

In some embodiments, the type of the first input data may be different from the type of the second input data. For example, in the image generation scenario, the first input data may be voice data or image data, and the second input data may be text data obtained based on the first input data and capable of reflecting the features of the to-be-generated image.

In some embodiments, the amount of the second input data may be the same as or different from the amount of the first input data. For example, if the first input data is voice data or image data, and the second input data is text data obtained based on the first input data, then the data volume of the second input data may be less than or equal to the data volume of the first input data; if the first input data is text data and the second input data is voice data or image data obtained based on the first input data, the data volume of the second input data may be greater than the data volume of the first input data.

102, generating third input data based on an obtained adjustment operation on the second input data.

In some embodiments, the adjustment operation on the second input data may be an adjustment operation on all the second input data, or may be an adjustment operation on the target data in the second input data. The target data of the second input data may be key feature data that can characterize the second input data, such as keywords. For example, if the second input data is text data “Please generate a puppy”, the keyword in the text data is the image generation object “puppy”.

In some embodiments, the adjustment operation for the second input data may correspond to the type of the second input data. If the second input data is text data, the adjustment operation for the second input data may include, but is not limited to, modifying, replacing, deleting and/or adding the text data, adjusting display parameters, expanding and/or replacing keywords in the text data. The display parameter adjustment operation may include the adjustment operation of parameters such as font, color, font size, handwriting and/or style of text data. For example, in the image generation scenario, the second input data is the text data “Please generate a puppy”. The adjustment operation for the text data “Please generate a puppy” can be an expansion operation of the keyword “puppy” in the text data “Please generate a puppy”, and the type, color, and quantity of the puppy can be expanded. For example, the color of the puppy can be expanded to obtain the expanded text data “Please generate a black puppy”, and the expanded text data “Please generate a black puppy” can be used as the third input data.

If the second input data is audio data, the adjustment operation for the second input data may include, but is not limited to, adjusting volume, adjusting pitch and/or adjusting timbre.

If the second input data is image data, the adjustment operation on the second input data may include, but is not limited to, a smearing operation, a marking operation, an element replacement operation and/or an image parameter adjustment operation. The image parameter adjustment operation may include an image contrast adjustment operation, an image brightness adjustment operation, an image saturation adjustment operation, etc.

103, generating a target file matching the user intent based on the user intent represented by the third input data.

In some embodiments, the user intent represented by the third input data may be identified through an intent recognition model, and then a text file, image file, video file or multi-modal multimedia data file that meets the user intent can be generated. For example, in the image generation scenario, the third input data is text data that can contain the user's intent of “Please generate a black puppy”. The text data “Please generate a black puppy” can be input into the intent recognition model (i.e., an intent interpretation model). The intent recognition model can infer and identify the user's intent of “generating an image of a black puppy”. Then the image generation model can generate an image containing a black puppy based on the user intent.

In some embodiments, a second processing instruction input into the target application may also be monitored. The second processing instruction may be an instruction for the third input data, and the third input data may be processed based on the second processing instruction to generate a corresponding target file. The second processing instruction may be a voice file generation instruction, an image file generation instruction, a video file generation instruction, etc.

Using this method, the first input data can be processed into the second input data input to the target application through the first processing instruction, and then the third input can be generated based on the adjustment operation on the second input data to generate the target file matching the user intent by using the user intent represented by the third input data. In this way, the user is guided to express his/her intention more accurately, or the user can make adjustment to obtain the third input data that is more in line with his/her intention, thereby generating a target file that accurately matches the user's intention and improving the user experience.

In some embodiments, obtaining the first processing instruction for the first input data may include one or more of processes A1-A4.

A1, generating the first processing instruction in response to obtaining a trigger operation of a first type of control acting on a first type of application, the first type of application being an application capable of responding to the first input data.

The first type of applications may include intelligent agent applications, image generation applications, text generation applications, or video generation applications, etc. Intelligent agent applications may include Lenovo Xiaotian or AI NOW, image generation applications may include Lenovo's creator zone application, text generation applications may include Lenovo's AI learning application, and video generation applications may include Sora (OpenAI's text-to-video model). The first type of applications can implement functions such as image generation, text generation, video generation, audio generation, AI image processing, image beautification or device control in response to the first input data.

The trigger operation of the first type of control acting on the first type of application may be a click operation, a drag operation, a double-click operation, etc. The first processing instruction may be a text generation instruction, a text polishing processing instruction, a text feature enhancement instruction, a picture-to-text conversion processing instruction, a voice-to-text conversion processing instruction, or a processing instruction combining the picture-to-text conversion processing instruction and the voice-to-text conversion processing instruction.

In some embodiments, the first type of control may include a functional control capable of expanding the prompt word of the first input data. FIG. 2 shows a user interface of an image generation application according to some embodiments of the present disclosure. As shown in FIG. 2, a user interface 200 includes a drawing area 201 and a text input area 202. The text input area 202 can be used for the user to input text data, and the drawing area 201 can be used to display the image drawn based on the text data input by the user. The text input area 202 includes a speech enhancement option 203 and a send option 204, the speech enhancement option 203 is a function control that can trigger the extension of the prompt word. As shown in FIG. 2, the user can move a cursor 205 to the speech enhancement option 203 for enhancing speech, and trigger the speech enhancement option 203 by clicking on the speech enhancement option 203. As shown in FIG. 2, the user can enter the text data “Help me draw a dog” in the text input area 202 and then click the “Enhanced Speech” option 203. After detecting that the user clicks the “Enhanced Speech” option 203, the image generation application can generate a first processing instruction indicating the extension of the prompt word.

A2, generating the first processing instruction in response to obtaining the trigger operation for the first input data to a second type of application.

The second type of application may be an application that can respond to or cannot respond to the first input data. The second type of application may be the same as the first type of application or different. For example, the second type of application may be an image generation application or a text generation application, etc. The second type of applications may also be a social application or a conference application, such as WeChat and Teams. If the second type of application is a social application or a conference application, the present disclosure can process the input data by calling a text generation model or an image generation model based on the input data in a user chat or a conference.

The trigger operation for the first input data input to the second type of application may include a copy and paste operation, a screenshot operation, a circle operation, a mark operation, or an edit operation, etc. For example, the second type of application is a chat software, which can call the image generation model, and the user can take a screenshot of the text data entered into the chat software. After the chat software detects the user's screenshot operation, it can obtain the captured image and extract the text data in the captured image, call the image generation model based on the text data, and generate an instruction for expanding the prompt word of the text data by the image generation model as the first processing instruction.

A3, generating a corresponding first processing instruction based on application information of a third type of application in response to obtaining first input data input to the third type of application.

The third type of application may be the same as or different from the first type of application. The application information of the third type of application may include an application type. In some embodiments, the first processing instruction for the first input data may be generated based on the application type of the third type of application. For example, if the third type of application is an image generation application and the first input data is text data, a first processing instruction for the first input data can be generated based on an image generation rule, for example, a processing instruction for the prompt word expansion can be generated to expand the image feature information corresponding to the first input data, to generate a more accurate image. If the third type of application is a text generation application and the first input data is text data, the first processing instruction for the first input data may be generated based on a text generation rule, for example, a first processing instruction for text expansion, text abbreviation or text summary extraction may be generated. If the third type of application is an audio generation application and the first input data is text data, the first processing instruction for the first input data may be generated based on an audio generation rule, for example, a first processing instruction for increasing the volume, changing the pitch, or changing the timbre may be generated.

A4, generating a corresponding first processing instruction based on the type of the first input data and/or application information of the source application.

In some embodiments, the type of the first input data may include text, image, audio, video, etc. The source application may be the application into which the first input data is input. For example, if the first input data is input into an image generation application, the source application is the image generation application.

In some embodiments, the first processing instruction for the first input data may be generated based on the type of the first input data. For example, if the first input data is text data, a text enhancement instruction may be generated as the first processing instruction; if the first input data is audio data, a volume amplification instruction may be generated as the first processing instruction.

In some embodiments, the first processing instruction may also be generated based on the application type or function type of the source application. The application type of the source application may include an image generation type, an audio generation type, a text generation type, etc. The function type of the source application may include a parameter adjustment function, a drawing function, a text-to-speech function, etc. For example, if the first input data is text data and the function type of the source application is a text-to-speech function, a text-to-speech instruction may be generated as the first processing instruction. If the first input data is audio data and the function type of the source application is a parameter adjustment function, a volume amplification instruction may be generated as the first processing instruction.

In some embodiments, the first processing instruction may also be generated based on the type of the first input data and the application type or function type of the source application. For example, if the first input data is image data and the application type of the source application is a text generation application, a first processing instruction for image-to-text conversion and text summary extraction may be generated for the first input data.

In some embodiments, processing the first input data into the second input data may include one or more of processes B1-B3. Processes B1-B3 may be independent processes.

B1, using a processing model that matches the first processing instruction to process the first input data into the second input data.

In some embodiments, the processing model that matches the first processing instruction may be an image generation model, a text generation model or a video generation model, etc. For example, if the first processing instruction is an instruction generated by the trigger operation of the prompt word expansion function control of the image generation application, the processing model matching the first processing instruction may be an image generation model, that is, the prompt word expansion model in the image generation application can be called to perform word expansion processing on the first input data. If the first processing instruction is an instruction generated by the trigger operation of the text expansion function control of the text generation application, the processing model that matches the first processing instruction may be a text generation model, that is, the text expansion model in the text generation application can be called to expand the first input data.

B2, processing the first input data into fourth input data based on the type of the first input data, and generating the first target data in the fourth input data to obtain the second input data.

In some embodiments, the fourth input data and processing methods obtained from different types of first input data may be different. For example, if the first input data is text data, then semantic analysis or intent recognition may be performed on the text data to extract keywords from the text data as the fourth input data. If the first input data is image data, then image features may be extracted from the image data to extract elements included in the image and convert these elements into corresponding text data as the fourth input data. If the first input data is audio data, then audio features may be extracted from the audio data, and the audio data may be converted into corresponding text data as the fourth input data.

In some embodiments, the first target data may include all or part of the fourth input data. For example, the first target data may include a keyword in the fourth input data, and the keyword may be a noun or a verb in the fourth input data. For example, if the fourth input data is “generate a black puppy”, the first target data may include the entire “generate a black puppy” of the fourth input data, and the first target data may also include the keywords “generate” and “puppy” of the fourth input data. Then, the prompt word expansion model or the text generation model in the image generation model can be used to generate the keywords “generate” and “puppy” to obtain the second input data “generate a little yellow dog running and jumping in the garden in the sun.”

B3, integrating and processing the first input data and its context data input to the target application to obtain the second input data.

In some embodiments, the first input data may be text data captured from an article or news, and the context data of the first input data may be text data associated with a scene in the first input data. Therefore, the scene features of the first input data may be supplemented by combining the context data of the first input data to generate the second input data. For example, in a short article, there is a description text “On a sunny afternoon, a puppy was lying on the ground playing”. If the text data “a puppy” in the short article is extracted as the first input data, the scene feature “bright afternoon” and the action feature “lying on the ground” of “a puppy” can be obtained by combining the context data of “a puppy”. By combining the scene feature “bright afternoon”, the action feature “lying on the ground” and the first input data “a puppy”, the second input data of “a puppy is lying on the ground” can be obtained.

In some embodiments, generating the third input data based on the obtained adjustment operation for the second input data may include one or more of processes C1-C3. Processes C1-C3 may be independent processes.

C1, generating the third input data based on the obtained selection operation of the recommended data for the second target data in the second input data and/or the editing operation for the second target data.

In some embodiments, the second target data may be all or part of the second input data. For example, the second target data may be keywords such as nouns, adjectives of nouns, and verbs in the second input data. The recommended data of the second target data may include other text data consistent with the second target data type. For example, if the second target data is text data for describing a color, the recommended data for the second target data may be text data describing another color different from the second target data. If the second target data is text data used to represent quantity, the recommended data for the second target data may be text data representing a different quantity than the second target data. The selection operation of the recommended data of the second target data in the second input data may include selecting the recommended data of the second target data to replace the second target data or changing the second target data to the recommended data of the second target data to obtain new text data as the third input data. The editing operation on the second target data may indicate that the user can directly edit the second target data to generate new text data as the third input data.

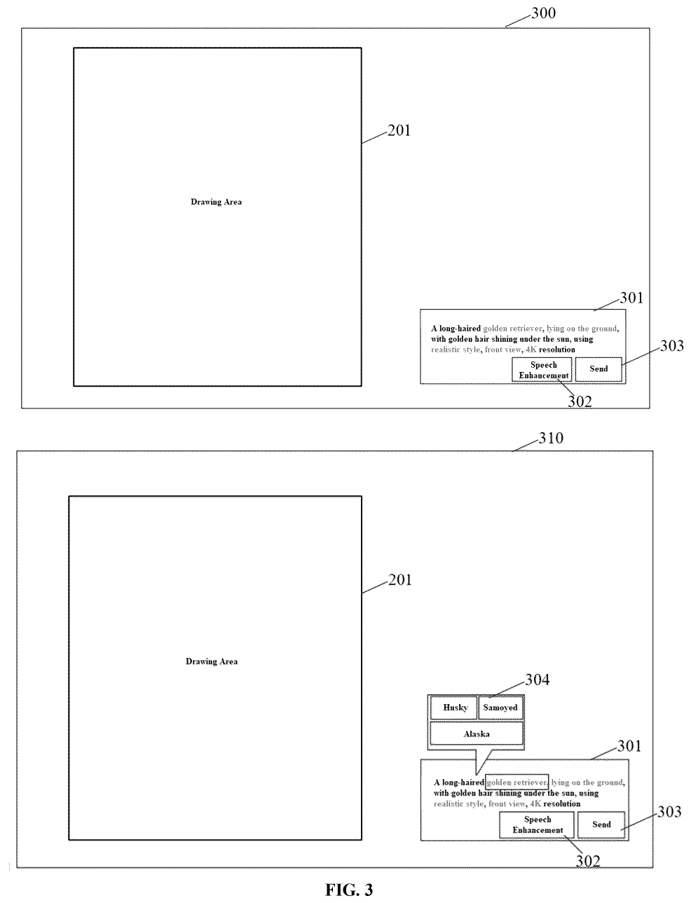

For example, in the user interface 200 shown in FIG. 2, if the user enters the text data “Help me draw a dog” in the text input area 202 and clicks on the “Speech Enhancement” option 203, the image generation application can display the interface shown in FIG. 3 after detecting that the user clicked on the “Speech Enhancement” option 203. FIG. 3 shows another user interface of the image generation application according to some embodiments of the present disclosure. As shown in FIG. 3, an interface 300 displayed after the image generation application detects that the user clicked the “Speech Enhancement” option 203 may include the drawing area 201, the text display area 301, the “Speech Enhancement” option 302 and the “Send” option 303. The drawing area 201 can be used to display the generated image, and the text display area 301 can be used to display the text data entered by the user and the text after the enhanced speech. After the user clicks the “Send” option 303, the image generation application can generate an image based on the text currently displayed in the text display area 301. As shown in FIG. 3, when the user enters the text data “Help me draw a dog” and clicks on the enhanced speech function, the image generation application can perform prompt word expansion processing on the text data “Help me draw a dog”, and then display the text data after the enhanced speech in the text display area 301 “A long-haired golden retriever, lying on the ground, with golden hair shining under the sun, using realistic style, front view, 4K resolution” and use the text data the enhanced conversation as the second input data. At this time, the user can also directly click on the extended prompt words such as “Golden Retriever” and “lying on the ground” in the text data after the enhanced speech. After the user clicks on the extended prompt word, the interface 310 can be displayed. The interface 310 displays a tag information display area 304. The tags in the user tag information display area 304 can be used to replace some features of the text data of “A long-haired golden retriever, lying on the ground, with golden hair shining under the sun, using realistic style, front view, 4K resolution” after the enhanced speech currently displayed in the text display area 301. For example, “Golden Retriever” can be replaced with “Husky” such that the generated image is an image of a Husky. Alternatively, the user can directly edit the extended prompt words such as “Golden Retriever” and “lying on the ground”, and can directly change “Golden Retriever” to “Husky” and/or change “lying on the ground” to “squatting on the ground”, etc. When the user finishes editing, the text data displayed in the text display area 301 is the third input data, and the image generation model can generate an image based on the third input data. As shown in FIG. 3, the image generation application performs prompt word expansion processing on the text data “Help me draw a dog” to obtain the text data of “A long-haired golden retriever, lying on the ground, with golden hair shining under the sun, using realistic style, front view, 4K resolution” after the speech enhancement. In the obtained text data, “golden hair,” “lying on the ground,” “realistic style,” “front view,” and “4K resolution” are key words that characterize the type, action, drawing style, drawing perspective, and clarity of the drawn object. The text display area 301 can display these key prompt words by highlighting, bolding or underlining, and the user can directly click or double-click these key prompt words to edit them. More specifically, after the user directly clicks or double-clicks these key prompt words, a text editing box may be displayed. The user may enter a key prompt word that meets his or her own intention in the text editing box to replace the current key prompt words. The text editing box may be displayed on the text display area 301. Alternatively, after the user clicks or double-clicks these key prompt words, one or more tags that can replace the clicked key prompt words can be displayed in the user tag information display area 304. As shown in FIG. 3, the tags corresponding to the key prompt word “Golden Retriever” include “Husky”, “Samoyed”, and “Alaska”, etc., and the user can replace the key prompt word by clicking on the tag that meets his or her intention.

Consistent with the present disclosure, the speech enhancement function can guide users to express their intentions more accurately or be used for user adjustments to obtain third input data that is more in line with the intention, thereby generating a target file that accurately matches the user's intention. In addition, users can also quickly switch prompt words that match their intentions through multiple tags corresponding to prompt words to realize rapid expansion of text, and quickly generate target files that accurately match user intentions to improve user experience.

In some embodiments, generating the third input data based on the obtained selection operation of the recommended data for the second target data in the second input data and/or the editing operation for the second target data may include one or more of processes D1-D3. Processes D1-D3 may be independent processes.

D1, in response to obtaining the trigger operation for a target keyword in the second input data, outputting a recommended word for the target keyword, and replacing the target keyword with the recommended word determined by the selection operation of a target recommended word to obtain the third input data.

In some embodiments, the trigger operation for the target keyword in the second input data may include circling the target keyword, voice triggering the target keyword, or moving the cursor to the location of the target keyword. After the target keyword is triggered, the recommended word for the target keyword can be displayed through pop-up windows or voice broadcasts. The recommended word can be other words with the same part of speech as the target keyword. The recommended word can be used to replace the target keyword. The recommended word may include one or more words. If there is only one recommended word, the user can use the recommended word to replace the target keyword after selecting it. If there are multiple recommended words, the user can select one of them to replace the target keyword. If the user does not select any recommended words, the target keyword may be replaced by the user's own recommended words. If the user has not selected any recommended words and the user has not entered any recommended words, it can be determined that the current target keyword will not be changed. For example, as shown in FIG. 3, the user can trigger the target keyword by moving the cursor to the location of the target keyword “Golden Retriever”, and multiple tags of “Husky”, “Samoyed” and “Alaska” will pop up on the interface in the user tag information display area 304. The multiple tags that pop up are the recommended words. Users can choose a recommended word that suits their intentions from the recommended words of “Husky”, “Samoyed” and “Alaska” to replace “Golden Retriever”. Users can also choose not to enter other recommended words that represent dog breeds. For example, “Chinese native dog” can be used to replace “Golden Retriever”. Alternatively, the user can choose not to select and enter a recommended word, and retain the original target keyword “Golden Retriever”.

D2, in response to obtaining the editing operation for the target keyword in the second input data, generating the third input data based on the edited keyword.

In some embodiments, the editing operation for the target keyword in the second input data may include modifying the target keyword. As shown in FIG. 3, if there is no recommended word that meets the user's intention in the multiple recommended words of “Husky”, “Samoyed” and “Alaska” that pop up in the user tag information display area 304, and the user is not satisfied with the target keyword “Golden Retriever”, the user can double-click the target keyword or input voice input to make a text input box pop up on the image generation application. Then, the user can directly enter the recommended word that meets his/her intention in the text input box to replace the target keyword “Golden Retriever”.

D3, in response to obtaining the trigger operation for the target keyword in the second input data, outputting the output effect of the recommended word for the target keyword, and replacing the target keyword with the recommended word determined by the selection operation of the target output effect to obtain the third input data.

In some embodiments, since the user may not understand or not know the specific object represented by the text, for example, the recommended words are “Husky”, “Samoyed” and “Alaska”, and the user may not know the appearance of “Husky”, “Samoyed” and “Alaska”, therefore, after the target keyword is triggered, the output effect of the recommended word for the target keyword may be output, and the output effect may include an image or voice introduction information corresponding to the recommended word for the target keyword. For example, if the recommended words are “Husky”, “Samoyed” and “Alaska”, images of the recommended words “Husky”, “Samoyed” and “Alaska” for the target keyword can be output such that the user can intuitively understand the meaning represented by the recommended words to facilitate user selection.

In some embodiments, the image generation application may call an external database or an internal database, which stores image information and/or voice introduction information corresponding to various recommended words. After the target keyword is triggered, the recommended words corresponding to the target keywords can be determined, and the image information and/or voice introduction information corresponding to each recommended word can be retrieved from the database as the output effect for output. The user can choose recommended words that better suit his/her intentions to replace the target keywords based on the output effect, thereby obtaining the replaced third input data.

C2, generating the third input data based on a configuration operation obtained for the configuration options in the configuration window for the second input data, the configuration options being used to update target data in the second input data.

In some embodiments, the configuration options may be options for configuring all or target data of the second input data. The target data of the second input data may be keywords such as nouns and verbs in the second input data. Part of the text data in the second input data may be updated by providing replacement words with the same part of the speech for the keywords to generate the third input data. If the second input data is video data, the target data may also be a key image frame in the video data. If the second input data is image data, the target data may also be a target object in the image data. If the second input data is audio data, the target data may also be a key audio segment in the audio data, etc.

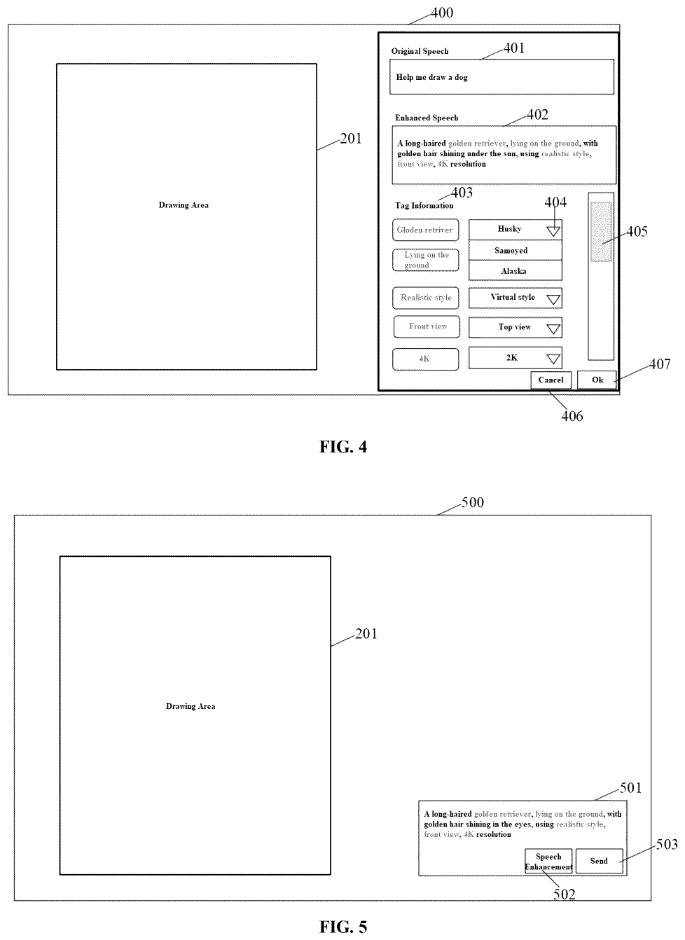

For example, in the user interface 200 shown in FIG. 2, if the user enters the text data “Help me draw a dog” in the text input area 202 and clicks on the “Speech Enhancement” option 203, the image generation application can display the interface shown in FIG. 4 after detecting that the user clicked on the “Speech Enhancement” option 203. FIG. 4 shows another user interface of the image generation application according to some embodiments of the present disclosure. As shown in FIG. 4, after the image generation application detects that the user clicks the “Speech Enhancement” option 203, the interface 400 displayed includes the drawing area 201, an original speech area 401, a speech enhancement area 402, a tag information area 403, a tag selection option 404, a tag area sliding button 405, a cancel option 406 and a confirmation option 407. The drawing area can be used to display the generated image, the original speech area 401 can be used to display the text data entered by the user, the tag information area 403 can be used to display the prompt words that can be selected to enhance the characteristics of the text data, and the tag selection function option 404 can be used to select a specific prompt word. The user can slide the tag area sliding button 405 to display the tag information hidden in the current interface, and the speech enhancement area 402 can used to display the text data generated based on the tag information selected by the user and the text data entered by the user. The user can click on the cancel option 406 to exit the speech enhancement function, and the user can click on the confirm function option 407 to confirm that the image is drawn based on the text data of the currently generated enhanced speech area. As shown in FIG. 4, when the user enters the text data “Help me draw a dog” and clicks the speech enhancement function, a prompt word may be displayed in the tag information area 403, and the prompt word may include information such as the type, drawing scene, drawing style, drawing perspective of the object to be drawn, and clarity of the image to be drawn. For example, the user selected the type of the drawing object as golden retriever, the drawing scene as lying on the ground, the drawing style as realistic style, the drawing perspective as front view, and the clarity of the drawing as 4K resolution in the displayed prompt words. Based on the information selected by the user, the image generation application can generate enhanced text data of “A long-haired golden retriever, lying on the ground, with golden hair shining under the sun, using realistic style, front view, 4K resolution” as the third input data. The third input data can be displayed in the speech enhancement area 402. When the user confirms that the enhanced speech is correct, he/she can click the confirmation function option 407 to display the interface shown in FIG. 5.

FIG. 5 shows another user interface of the image generation application according to some embodiments of the present disclosure. As shown in FIG. 5, when the user confirms that the enhanced speech is correct and clicks the confirmation option, the interface 500 can be displayed. The interface 500 includes the drawing area 201, an enhanced speech display area 501, a speech enhancement option 502, and a send option 503. The enhanced speech display area 501 display the text “A long-haired golden retriever, lying on the ground, with golden hair shining under the sun, using realistic style, front view, 4K resolution” obtained after the previous speech enhancement. That is, the enhanced speech display area 501 can display the text data generated by the image generation application after optimizing the text input by the user. As shown in FIG. 5, if the user clicks on the speech enhancement option 502, the text can be further enhanced based on the text data “A long-haired golden retriever, lying on the ground, with golden hair shining under the sun, using realistic style, front view, 4K resolution”. If the user clicks the send option 503, the image generation model can generate an image based on the enhanced text data “A long-haired golden retriever, lying on the ground, with golden hair shining under the sun, using realistic style, front view, 4K resolution”.

In some embodiments, generating the third input data based on the configuration operation of the configuration options in the configuration window for the second input data may include the processes E1-E3.

E1, displaying a configuration window for the second input data, the configuration window displaying configuration options corresponding to the target keyword in the second input data.

In some embodiments, the configuration window may be a window for the target keyword of the second input data, and one or more configuration options for replacing the target keyword may be displayed in the configuration window. As shown in FIG. 4, the configuration window may be a window 403 displaying tag information. The tags displayed in the configuration window are configuration options. The configuration options may include multiple configuration options for different target keywords of the second input data. As shown in FIG. 4, the configuration options include options for representing the type of the object to-be-drawn “dog” in the second output data. The types of dogs may include “Golden Retriever”, “Husky”, “Alaskan”, “Samoyed”, etc. The user can select a specific configuration option representing the type of object to-be-drawn by clicking button 404. The configuration options also include options for the drawing style of the object to-be-drawn “dog” in the second output data, and the drawing style may include “realistic style” and “virtual style” etc. The user can select a specific drawing style configuration option by clicking button 404. The configuration options also include options for representing the action type of the object to-be-drawn “dog” in the second output data, options for drawing perspective, and options for image clarity, etc. The user can also pull down the tag area sliding button 405 to display more configuration options.

In some embodiments, if there is no configuration option that meets the user's intent in the displayed configuration options, the user may double-click the original speech area 401 or the speech enhancement area 402 to pop up a prompt input box (e.g., text input box), and directly enter text that meets the user's intent in the prompt input box to replace the target keyword. The configuration window and the prompt input box can be in the same window or not.

E2, in response to obtaining a trigger operation on the target configuration options, displaying recommended options of the target configuration options.

In some embodiments, the recommended options of the target configuration options can be further displayed by clicking the target configuration options, sliding the target configuration options, dragging the target configuration options, and voice selecting the target configuration options. As shown in FIG. 4, the user can select a configuration option representing a drawing object type as a target configuration option by clicking button 404, and one or more recommended options in the target configuration option are displayed, such as “Golden Retriever”, “Husky”, “Alaskan”, and “Samoyed”. The user can select the recommended option that meets his/her intent in the recommended options to replace the target keyword corresponding to the target configuration option.

E3, replacing the target keyword in the second input data by the recommended option determined by a selection operation of the target recommended option to obtain the third input data.

As shown in FIG. 4, if the user selects Husky from the recommended options such as “Golden Retriever”, “Husky”, “Alaska” and “Samoyed”, then Husky is the target recommended option. The target keyword “Golden Retriever” in the enhanced speech text can be replaced with Husky to obtain the third input data.

C3, obtaining context data associated with the second input data, and using the context data to update the second input data to generate the third input data.

In some embodiments, the keywords of the second input data may be adjusted based on the context data associated with the second input data to generate the third input data.

For example, if the second input data is a piece of text data “Help me draw a dog” generated by a type of chat assistant, the image generation application can call other text data associated with the second input data in the chat software, such as historical conversations, to obtain historical conversations such as “like black puppies”, “puppies lying down”, and “Husky”. Then, the second input data can be updated and processed in combination with the historical conversations, the user's intent can be analyzed, and a more specific third input data “draw a black lying husky” can be generated.

In some embodiments, the third input data may also be generated based on the obtained text update instruction for the second input data, the text update instruction being an instruction for supplementing the text of the second input data.

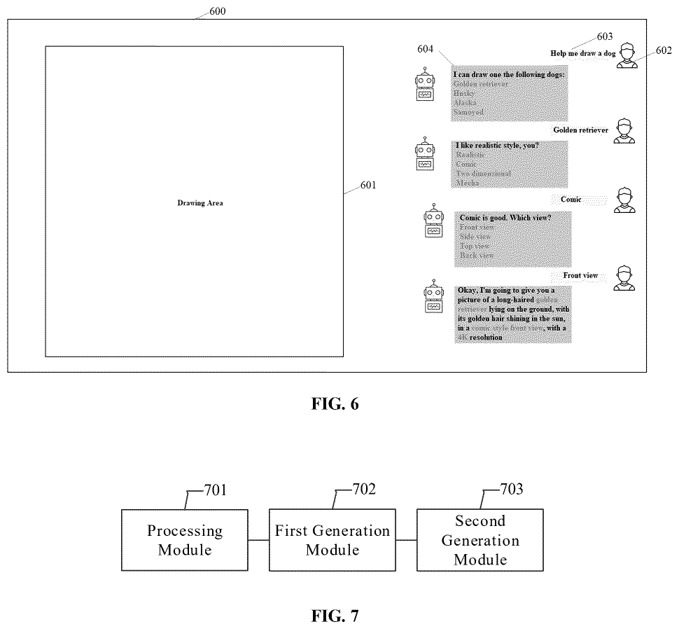

FIG. 6 shows another user interface of the image generation application according to some embodiments of the present disclosure. As shown in FIG. 6, the image generation application can provide the user with a text update interface 600, which includes a drawing area 601, a user input text area 603, and a tag display area 604. The user 602 may input the second input data “Help me draw a dog”. After the image generation application detects the second input data input by the user 602, it can identify the second input data, extract keywords from the second input data, and display tags for the keywords. Tags for keywords can be other words that can replace keywords and have the same part of speech and word class as the keywords. Tags for keywords can also be supplementary words for keywords. For example, when a keyword is a noun that represents a specific object, the tag for the keyword may be the type of the object represented by the keyword. Keywords may include nouns, verbs, and adjectives in text data. As shown in FIG. 6, after the user 602 inputs the second input data “Help me draw a dog”, the image generation application identifies the second input data “Help me draw a dog” and identifies that the object to-be-drawn is a dog. Then, the image generation application can display the tags “Golden Retriever”, “Husky”, “Alaskan” and “Samoyed” representing the type of the object to-be-drawn “dog” for the object to-be-drawn. The user can choose between the tags “Golden Retriever”, “Husky”, “Alaskan”, and “Samoyed”. As shown in FIG. 6, the user 602 selects the tag “Golden Retriever”. Based on the type of the object to-be-drawn selected by the user, the image generation application can also display the corresponding tags for the image style of the second input data “Help me draw a dog” for the user to choose. As shown in FIG. 6, the tags representing the drawing styles are “realistic”, “comic”, “two dimensional” and “mecha style”. Based on the user 602 selecting the “comic” style, the image generation application can further display the corresponding tags for the drawing perspective of the second input data “Help me draw a dog”. As shown in FIG. 6, the tags “front view”, “side view”, “top view” and “back view” representing the drawing perspective can be displayed. After the user selects the drawing perspective of “front view”. Based on the user-selected tags “Golden Retriever”, “comic”, and “front view” the image generation application generates text data “Okay, I'm going to give you a picture of a long-haired golden retriever lying on the ground, with its golden hair shining in the sun, in a cartoon-style front view, with a 4K resolution.” as the third input data.

As shown in FIG. 6, the image generation application can guide the user to expand the features of the second input data in the form of a dialogue with the user. The number of expansions of the image generation application is generally not limited. As shown in FIG. 6, after the user selects the “front view” drawing perspective, the image generation application may further display the corresponding tags for the image clarity of the second input data “Help me draw a dog” for the user to select, such as displaying “4K resolution” and “2K resolution” tags.

Consistent with the present disclosure, prompt words can be displayed in a way of guiding user dialogue, guiding users to express their intentions more accurately or allowing users to make adjustments to obtain the third input data that better matches their intentions, thereby generating a target file that accurately matches the user's intent and improving the user experience.

In some embodiments, generating the third input data based on the obtained adjustment operation for the second input data may include one or more of processes F1-F3.

F1, when the second input data is image data, in response to obtaining a trigger operation for a target object in the image data, outputting a recommended object for the target object, and replacing the target object with the recommended object determined by a selection operation for the target recommended object to obtain the third input data.

In some embodiments, if the second data is image data, the target object in the image data may include people, objects, and background in the image. The user may trigger the target object by clicking the target object in the image, circling the target object area, painting the target object area, or sliding the target object area. In some embodiments, outputting the recommended object for the target object may include an element capable of replacing the target object. For example, if the target object is a person, the recommended object may be a person of a different gender, posture, and/or age than the target object; if the target object is a cup, the recommended object may be a cup of a different color and/or shape than the target object; if the recommended object is a landscape background, the recommended object may be a background of a different landscape or a background element of a different color. The recommended object may include one or more.

In some embodiments, when the second input data is image data, if the target object in the image is triggered, a recommended list of recommended objects for the target object may pop up for the user to select. The user can select the target recommended object by clicking or circling it, and replace the target object with the target recommended object to generate the third input data.

F2, when the second input data is image data, in response to obtaining a trigger operation for a target object in the image data, outputting a recommended object for the target object, and replacing the target object with the recommended object determined by a selection operation for the target recommended object to obtain the third input data.

In some embodiments, if the second data is audio data, the target segment in the audio data may include a segment of a key object such as a key person or a key object involved in the audio. The audio data can be processed to identify the segments representing key objects, and the user can trigger the target segment by clicking the target segment logo or sliding the audio data to select the target segment. The recommended segment of the target segment may include text data or voice data that can replace the target segment. For example, the target segment is voice information describing the weather conditions of a certain place, the recommended segment of the target segment can be an introductory voice or text describing the local customs and people. If the recommended segment is text information, the text information can be converted into voice information first, and then the target segment can be replaced with the voice information to obtain the third input data. If the recommended segment is audio data, the target segment may be directly replaced with the recommended segment to obtain the third input data.

F3, when the second input data is video data, in response to obtaining a trigger operation for a target image frame in the video data, outputting a recommended image frame for the target image frame, and replacing the target image frame with the recommended image frame determined by a selection operation for the target recommended image frame to obtain the third input data.

In some embodiments, if the second data is video data, the target image frame in the video data may include image frames involving key objects such as key persons and key objects in the video. The video data can be processed, and the image frame representing the key object can be identified as the target image frame. The user can trigger the target image frame by clicking the identifier of the target image frame. The recommended image frame of the target image frame may include image data capable of replacing one or more elements in the target image frame. For example, the target image frame is an image of a husky lying on the ground, and the recommended image frame of the target image frame may be an image frame corresponding to the change of information such as the species, category, posture and/or quantity of the object in the target image frame. For example, the recommended image frame of the target image frame may be an image of a golden retriever lying on the ground. The recommended image frame of the target image frame may include one or more. If the user selects a recommended image frame of the target image frame, the target image frame can be replaced by the recommended image frame to obtain third input data.

Processes F1-F3 may be independent processes.

In some embodiments, generating a target file matching the user intent based on the user intent represented by the third input data may include processes G1-G2.

G1, generating the second processing instruction based on attribute information of the target application and/or the user intent represented by the third input data.

In some embodiments, the attribute information of the target application may include the type of the target application. For example, the types of target applications may include image generation applications, video generation applications, audio generation applications, etc. The user intent represented by the third input data may include the intent of generating an image file, a video file, an audio file, etc. for the object included in the third input data.

In some embodiments, if the target application has an image generation function, a video generation function or an audio generation function, the second processing instruction may be generated based on target application. The second processing instruction may be a processing instruction for performing image generation, video generation, or audio generation on the third input data. In some embodiments, the target application may not have image generation, video generation, and audio generation function, for example, when the target application is a chat software. When the target application does not have image generation function, video generation function and audio generation function, the target application needs to process the third input data to obtain the user's intent to generate a second processing instruction corresponding to the user's intent. The second processing instruction generally includes an instruction to call a processing model or a model service corresponding to the user's intent, and to use the called processing model to process the third input data.

G2, generating and processing the third input data using a processing model or a model service corresponding to the second processing instruction to obtain the target file that matches the attribute information and the user's intent.

In some embodiments, the processing model corresponding to the second processing instruction may include a large model local to the electronic device, for example, an image generation model, a text generation model, a video generation model, etc. local to the electronic device. The model service corresponding to the second processing instruction may include a service interface provided by the cloud that can realize image generation, text generation and video generation. The electronic device can send the third processed data to the cloud through the service interface to utilize the model service of the cloud to process the third input data and feed back the processing result to the electronic device.

For example, if the third input data is text data “draw a husky lying on the ground”, and the target application generally does not have image generation function, video generation function and audio generation function, then the target application can identify the user intent of the third input data “draw a husky lying on the ground”, draw an image of a husky lying on the ground, and generate a second processing instruction of “drawing an image file of a husky lying on the ground”. The target application can then call the model service interface on the cloud and send the second text processing instruction to the cloud. The cloud uses an image generation model to generate a corresponding image file for the text data in the second processing instruction “draw an image file of a husky lying on the ground”, and feeds the image file back to the electronic device. The target file is the target file that matches the user's intent.

In some embodiments, generating a target file matching the user intent based on the user intent represented by the third input data may also include one of more of processes H1-H2. Processes H1-H2 may be independent processes.

H1, obtaining user profile information of the target user, and generating and processing the third input data with reference to the user profile information to obtain a target file that matches the user's intent.

In some embodiments, the user profile information may include user attribute information and user behavior information, etc. The attribute information may include the user's age, occupation, gender, etc., and user behavior information may include the user's behavior log data of using the target application, etc. In some embodiments, the user's interest can be analyzed based on the user profile information, and the user's interest can be referred to when processing the third input data. More specifically, clustering models, association rule mining models or information recommendation models can be used to identify user profiles and identify similar user groups with similar behaviors such that the user's interest can be predicted based on the interest of this type of user group. For example, if it is identified that a user group of female gender likes to generate anime images, the third input data may be processed based on the interest information of the user group to obtain an anime-style image file that matches the user's intent as the target file. In some embodiments, the third input data may also be generated and processed with reference to the user profile information to obtain a video file or an audio file that matches the user's intent as a target file.

H2, obtaining current environment information of the electronic device, and generating and processing the third input data with reference to the environment information to obtain a target file that matches the user's intent.

In some embodiments, the environment in which the electronic device is located may also affect the target file. For example, if an audio file about weather conditions needs to be generated, and the environmental information of the electronic device can reflect the weather conditions at the time, the target application can use the environmental information of the electronic device and analyze the current weather conditions to generate an audio file about the weather conditions in combination with the current weather conditions.

In another example, the environmental information of the electronic device may include the application scenario information of the electronic device. For example, the electronic device is a mobile phone, the user can interact with the electronic device through a voice assistant, the target file is a video file, and the environmental information of the electronic device can include the user's preference information for the video information expressed by voice in the environment. For example, if a user prefers a video with a 4:3 aspect ratio, the target application can collect the user's voice information and analyze the user's preference. When generating a video file, the target application can refer to the user's preference to generate a video file with a 4:3 aspect ratio as the target file.

Based on the same inventive concept, the data processing method provided by the above embodiment of the present disclosure, embodiments of the present disclosure also provide a data processing device. FIG. 7 is a schematic structural diagram of a data processing device according to some embodiments of the present disclosure.

As shown in FIG. 7, the data processing device includes a processing module 701, a first generation module 702 and a second generation module 703.

In some embodiments, the processing module 701 may be configured to process the first input data into the second input data in response to obtaining a first processing instruction for the first input data, the first input data being data input to a target application.

In some embodiments, the first generation module 702 may be configured to generate the third input data based on the obtained adjustment operation of the second input data.

In some embodiments, the second generation module 703 may be configured to generate a target file matching the user intent based on the user intent represented by the third input data.

Using this device, the first input data can be processed into the second input data input to the target application through the first processing instruction, and then the third input can be generated based on the adjustment operation on the second input data to generate the target file matching the user intent by using the user intent represented by the third input data. In this way, the user is guided to express his/her intention more accurately, thereby generating a target file that accurately matches the user's intention and improving the user experience.

In some embodiments, the processing module 701 obtaining the first processing instruction for the first input data may include one or more of generating the first processing instruction in response to obtaining a trigger operation of a first type of control acting on a first type of application, the first type of application being an application capable of responding to the first input data; generating the first processing instruction in response to obtaining the trigger operation for the first input data to a second type of application, the second type of application being an application that can or cannot respond to the first input data; generating a corresponding first processing instruction based on application information of a third type of application in response to obtaining first input data input to the third type of application; generating a corresponding first processing instruction based on the type of the first input data and/or application information of the source application.

In some embodiments, the processing module 701 processing the first input data into the second input data may include one or more of using a processing model that matches the first processing instruction to process the first input data into the second input data; processing the first input data into fourth input data based on the type of the first input data, and generating the first target data in the fourth input data to obtain the second input data; integrating and processing the first input data and its context data input to the target application to obtain the second input data.

In some embodiments, the first generating module 702 generating the third input data based on the obtained adjustment operation for the second input data may include one or more of generating the third input data based on the obtained selection operation of the recommended data for the second target data in the second input data and/or the editing operation for the second target data; generating the third input data based on a configuration operation obtained for the configuration options in the configuration window for the second input data, the configuration options being used to update target data in the second input data; obtaining context data associated with the second input data, and using the context data to update the second input data to generate the third input data.

In some embodiments, the first generating module 702 generating the third input data based on the obtained selection operation of the recommended data for the second input data in the second input data and/or the editing operation for the second target data may include one or more of, in response to obtaining the trigger operation for a target keyword in the second input data, outputting a recommended word for the target keyword, and replacing the target keyword with the recommended word determined by the selection operation of a target recommended word to obtain the third input data; in response to obtaining the editing operation for the target keyword in the second input data, generating the third input data based on the edited keyword; in response to obtaining the trigger operation for the target keyword in the second input data, outputting the output effect of the recommended word for the target keyword, and replacing the target keyword with the recommended word determined by the selection operation of the target output effect to obtain the third input data.

In some embodiments, the first generating module 702 generating the third input data based on the obtained adjustment operation for the second input data may include one or more of, when the second input data is image data, in response to obtaining a trigger operation for a target object in the image data, outputting a recommended object for the target object, and replacing the target object with the recommended object determined by a selection operation for the target recommended object to obtain the third input data; when the second input data is image data, in response to obtaining a trigger operation for a target object in the image data, outputting a recommended object for the target object, and replacing the target object with the recommended object determined by a selection operation for the target recommended object to obtain the third input data; when the second input data is video data, in response to obtaining a trigger operation for a target image frame in the video data, outputting a recommended image frame for the target image frame, and replacing the target image frame with the recommended image frame determined by a selection operation for the target recommended image frame to obtain the third input data.

In some embodiments, the second generation module 703 may be configured to display a configuration window for the second input data, the configuration window displaying configuration options corresponding to the target keyword in the second input data; in response to obtaining a trigger operation on the target configuration options, display recommended options of the target configuration options; replace the target keyword in the second input data by the recommended option determined by a selection operation of the target recommended option to obtain the third input data.

In some embodiments, the second generation module 703 may be configured to generate the second processing instruction based on attribute information of the target application and/or the user intent represented by the third input data; generate and process the third input data using a processing model or a model service corresponding to the second processing instruction to obtain the target file that matches the attribute information and the user's intent.

In some embodiments, the second generation module 703 may be configured to generate a target file matching the user intent based on the user intent represented by the third input data may include one or more of obtaining user profile information of the target user, and generating and processing the third input data with reference to the user profile information to obtain a target file that matches the user's intent; obtaining current environment information of the electronic device, and generating and processing the third input data with reference to the environment information to obtain a target file that matches the user's intent.

Embodiments of the present disclosure further provide an electronic device and a readable storage medium.

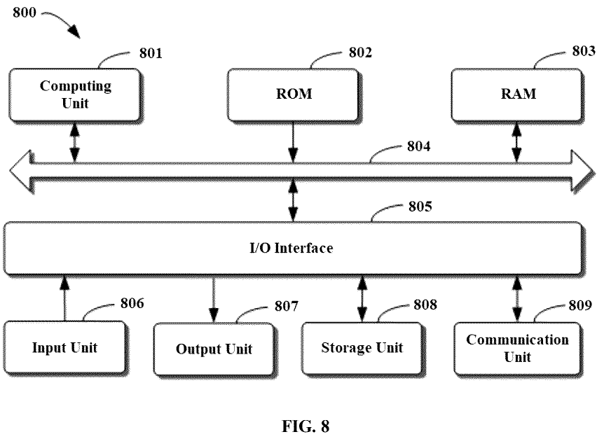

FIG. 8 illustrates a schematic hardware structural diagram of an electronic device 800 according to some embodiments of the present disclosure. The electronic device can include various types of digital computers, such as a laptop, a desktop, a workstation, a personal digital assistant, a server, a blade server, a mainframe computer, and other suitable computers. The electronic device can also include various types of mobile apparatuses, such as personal digital assistants, cellular phones, smartphones, wearable devices, and other similar computing apparatuses. The members, the connection and relationship of the members, and the functions of the members can be only used as examples and are not intended to limit the present disclosure described and/or required in the present specification.

As shown in FIG. 8, the electronic device 800 includes a computing unit 801. The computing unit 801 can be configured to perform various appropriate actions and processing according to the computer program stored in the ROM 802 and the computer program loaded into the RAM 803 from the storage unit 808. In the RAM 803, various programs and data required by the operation of the electronic device 800 can be stored. The computing unit 801, the ROM 802, and the RAM 803 can be connected to each other through the bus 804. The I/O interface 805 is also connected to the bus 804.

A plurality of members of the electronic device 800 can be connected to the I/O interface 805. The plurality of members can include an input unit 806, e.g., a keyboard, a mouse, etc., an output unit 807, e.g., various types of display screens and speakers, a storage unit 808, e.g., magnetic discs, optical discs, etc., and a communication unit 809, e.g., a network card, a modem, and a wireless communication transceiver. The communication unit 809 can allow the electronic device 800 to exchange information/data with another device through a computing network such as the Internet and/or various telecommunications networks.

The computing unit 801 can include various general-purpose and/or special-purpose processing assemblies having the processing and computing capabilities. In some embodiments, the computing unit 801 can include but is not limited to a CPU, a GPU, various special-purpose AI computing chips, various computing units running the machine learning model, a digital signal processor (DSP), and any suitable processor, controller, and microcontroller, such as touch controller. The computing unit 801 can perform the methods and processing above, e.g., a control method. For example, in some embodiments, the control method can be implemented as a computer software program. The computer software program can be stored in the machine-readable medium, e.g., a storage unit 808. In some embodiments, a part of or all of the computer programs can be loaded into and/or installed at the electronic device through the ROM 802 and/or the communication unit 809. When the computer program is loaded at RAM 803 and executed by the computing unit 801, the one or more steps of the control method can be performed. In some other embodiments, the computing unit 801 can be configured to perform the data processing method through any other appropriate method (e.g., with the firmware).

In some embodiments, the electronic device 800 may also include an image acquisition device.

Various embodiments of the above systems and technologies of the present disclosure can be implemented in digital electronic circuit systems, integrated circuit systems, field programmable gate arrays (FPGAs), application specific integrated circuits (ASICs), application specific standard products (ASSPs), systems on a chip (SOC), complex programmable logic device (CPLD), computer hardware, firmware, software, and/or a combination thereof. Embodiments of the present disclosure can be implemented in one or a plurality of computer programs. The one or more computer programs can be executed and/or explained in a programmable system of at least one programmable processor. The programmable processor can be a special-purpose or general-purpose programmable processor and can receive data and instructions from the storage system, at least one input apparatus, and at least one output apparatus and transfer the data and the instructions to the storage system, the at least one input apparatus, and the at least one output apparatus.

Program codes for implementing the methods of the present disclosure can be written in any combination of one or more programming languages. These program codes can be provided to a processor or controller of a general-purpose computer, special-purpose computer, or other programmable data processing apparatus. Thus, when the program codes are executed by the processor or controller, the functions/operations defined in the flowchart and/or block diagram can be implemented. The program codes can be completely or partially executed at the machine, the program codes can be partially executed at the machine as an independent software packet and partially executed at the remote machine or completely executed at the remote machine or server.

In the context of the present disclosure, the machine-readable medium can be a tangible medium, which can include or store the program for the instruction execution system, apparatus, or device to user or used in connection with the instruction execution system, apparatus, or device. The machine-readable medium can be a machine-readable signal medium or machine-readable storage medium. The machine-readable medium can include but is not limited to electrical, magnetic, optical, electromagnetic, infrared, or semiconductor system, apparatus, or device, or any appropriate assembly of the above content. The machine-readable storage medium can include electrical connections based on one or more wires, laptop disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof.

To provide interaction with a user, the systems and technology can be implemented at the computer. The computer can include a display apparatus (e.g., a CRT (cathode ray tube) or LCD (liquid crystal display) monitor) configured to display information to the user and a keyboard and a pointing apparatus (e.g., a mouse or a trackball). The user can provide input to the computer through the keyboard and the pointing apparatus. Other types of apparatuses can also be configured to provide interaction with the user. For example, the feedback provided to the user can be any form of sensor feedback (e.g., visual feedback, auditory feedback, or tactile feedback). The input from the user can be received in any format (including sound input, auditory input, and tactile input).

The system and technology can be implemented at a computer system (e.g., data server) including back-end members, a computer system (e.g., application server), or a computer system (e.g., user computer including a graphic user interface or a network browser, the user can interact with the implementation of the system and technology through the graphic user interface a or the network browser, a computer system including a combination of the back-end members, intermediate members, or front-end members. Members of the system can be mutually connected with each other through the digital and data communication (e.g., communication network) of any type or medium. For example, the communication network can include a local area network (LAN), a wide area network (WAN), and the Internet.

The computer system can include a client end and a server. The client and the server are generally away from each other and typically interact with each other through the communications network. The relationship between client and server can be created by a computer program running on a corresponding computer and having a client-server relationship with each other. The server can be a cloud server, a distributed system server, or a server combined with a blockchain.

The various forms of processes shown above can be used to reorder, add or delete steps. For example, the steps of the present disclosure can be executed in parallel, in sequence, or in different orders, as long as the desired results of the technical solution of the present disclosure can be realized, which is not limited in the present disclosure.

In addition, the terms “first” and “second” are used for descriptive purposes only, and cannot be understood as indicating or implying relative importance or implicitly indicating the number of indicated technical features. Therefore, the features defined as “first” and “second” can explicitly or implicitly include at least one of the features. In the description of the present disclosure, “a plurality of” can mean two or more than two, unless otherwise clearly and specifically defined.

The above are only some embodiments of the present disclosure. However, the scope of the present disclosure is not limited to these. Those skilled in the art can easily think of modifications or substitutions. The modifications and substitutions are within the scope of the present disclosure. Thus, the scope of the present disclosure is subjected to the scope of the claims.

What is claimed is:

1. A data processing method comprising:
processing first input data into second input data in response to obtaining a first processing instruction for the first input data, the first input data being data input to a target application;
generating third input data based on an obtained adjustment operation for the second input data; and
generating a target file matching a user intent based on the user intent represented by the third input data.

2. The method of claim 1, wherein obtaining the first processing instruction for the first input data includes one or more of:
generating the first processing instruction in response to obtaining a trigger operation of a first type of control acting on a first type of application, the first type of application being an application capable of responding to the first input data
generating the first processing instruction in response to obtaining the trigger operation for the first input data input to a second type of application, the second type of application being an application configured to or configured not to respond to the first input data;
generating a corresponding first processing instruction based on application information of the third input data in response to obtaining the first input data input to a third type of application; and
generating the corresponding first processing instruction based on a type of the first input data and/or the application information of a source application.

3. The method of claim 1, wherein processing the first input data into the second input data includes one or more of:
processing the first input data into the second input data using a processing model matching the first processing instruction;
processing the first input data into fourth input data based on the type of the first input data, and generating and processing first target data in the fourth input data to obtain the second input data; and
integrating and processing the first input data input to the target application and its context data to obtain the second input data.

4. The method of claim 1, wherein generating the third input data based on the obtained adjustment operation for the second input data includes one or more of:
generating the third input data based on an obtained selection operation of recommended data for second target data in the second input data and/or an editing operation for the second target data;
generating the third input data based on an obtained configuration operation for a configuration option in a configuration window for the second input data, the configuration option being used to update the target data in the second input data; and
obtaining context data associated with the second input data, and using the context data to update the second input data to generate the third input data.

5. The method of claim 4, wherein generating the third input data based on the obtained selection operation of the recommended data for the second target data in the second input data and/or the editing operation for the second target data includes one or more of:
in response to obtaining the trigger operation for a target keyword in the second input data, outputting a recommended word for the target keyword, and replacing the target keyword with the recommended word determined by the selection operation for the target recommended word to obtain the third input data;
in response to obtaining the editing operation for the target keyword in the second input data, generating the third input data based on the edited keyword; and
in response to obtaining the trigger operation for the target keyword in the second input data, outputting an output effect of the recommended word for the target keyword, and replacing the target keyword with the recommended word determined by the selection operation for the target output effect to obtain the third input data.

6. The method of claim 4, wherein generating the third input data based on the obtained adjustment operation for the second input data includes one or more of:
when the second input data is image data, in response to obtaining the trigger operation for a target object in the image data, outputting a recommended object for the target object, and replacing the target object with the recommended object determined by the selection operation on the target recommended object to obtain the third input data;
when the second input data is audio data, in response to obtaining the trigger operation for a target segment in the audio data, outputting a recommended segment for the target segment, and replacing the target segment with the recommended segment determined by the selection operation on the target recommended segment to obtain the third input data; and
when the second input data is video data, in response to obtaining the trigger operation for a target image frame in the video data, outputting recommended image frame for the target image frame, and replacing the target image frame with the recommended image frame determined by the selection operation on the target recommended image frame to obtain the third input data.

7. The method of claim 4, wherein generating the third input data based on the configuration operation of the configuration option in the configuration window for the second input data includes:
displaying the configuration window for the second input data, the configuration window displaying the configuration option corresponding to the target keyword in the second input data;
in response to obtaining the triggering operation on the target configuration option, displaying a recommended option of the target configuration option; and
replacing the target keyword in the second input data with the recommended option determined by the selection operation of the target recommended option to obtain the third input data.

8. The method of claim 1, wherein generating the target file matching the user intent based on the user intent represented by the third input data includes:
generating a second processing instruction based on attribute information of the target application and/or the user intent represent by the third input data; and
generating the third input data using a processing model or a model service corresponding to the second processing instruction to obtain the target file matching the attribute information and the user intent.

9. The method of claim 1, wherein generating the target file matching the user intent based on the user intent represented by the third input data further includes one or more of:
obtaining user profile information of a target user, and generating the third input data with reference to the user profile information to obtain the target file matching the user intent; and
obtaining current environment information of an electronic device, and generating the third input data with reference to the environment information to obtain the target file matching the user intent.

10. A data processing device comprising:
a processing module, the processing module being configured to process first input data into second input data in response to obtaining a first processing instruction for the first input data, the first input data being data input to a target application;
a first generation module, the first generation module being configured to generate third input data based on an obtained adjustment operation for the second input data; and
a second generation module, the second generation module being configured to generate a target file matching a user intent based on the user intent represented by the third input data.

11. The device of claim 10, wherein the processing module is further configured to:
generate the first processing instruction in response to obtaining a trigger operation of a first type of control acting on a first type of application, the first type of application being an application capable of responding to the first input data;
generate the first processing instruction in response to obtaining the trigger operation for the first input data input to a second type of application, the second type of application being an application configured to or configured not to respond to the first input data;
generate a corresponding first processing instruction based on application information of the third input data in response to obtaining the first input data input to a third type of application; and
generate the corresponding first processing instruction based on a type of the first input data and/or the application information of a source application.

12. The device of claim 10, wherein the processing module is further configured to:
process the first input data into the second input data using a processing model matching the first processing instruction;
process the first input data into fourth input data based on the type of the first input data, and generate and process first target data in the fourth input data to obtain the second input data; and
integrate and process the first input data input to the target application and its context data to obtain the second input data.

13. The device of claim 10, wherein the first generation module is further configured to:
generate the third input data based on an obtained selection operation of recommended data for second target data in the second input data and/or an editing operation for the second target data;
generate the third input data based on an obtained configuration operation for a configuration option in a configuration window for the second input data, the configuration option being used to update the target data in the second input data; and
obtain context data associated with the second input data, and use the context data to update the second input data to generate the third input data.

14. The device of claim 13, wherein the first generation module is further configured to:
in response to obtaining the trigger operation for a target keyword in the second input data, output a recommended word for the target keyword, and replace the target keyword with the recommended word determined by the selection operation for the target recommended word to obtain the third input data;
in response to obtaining the editing operation for the target keyword in the second input data, generate the third input data based on the edited keyword; and
in response to obtaining the trigger operation for the target keyword in the second input data, output an output effect of the recommended word for the target keyword, and replace the target keyword with the recommended word determined by the selection operation for the target output effect to obtain the third input data.

15. The device of claim 13, wherein the first generation module is further configured to:
when the second input data is image data, in response to obtaining the trigger operation for a target object in the image data, output a recommended object for the target object, and replace the target object with the recommended object determined by the selection operation on the target recommended object to obtain the third input data;
when the second input data is audio data, in response to obtaining the trigger operation for a target segment in the audio data, output a recommended segment for the target segment, and replace the target segment with the recommended segment determined by the selection operation on the target recommended segment to obtain the third input data; and
when the second input data is video data, in response to obtaining the trigger operation for a target image frame in the video data, output recommended image frame for the target image frame, and replace the target image frame with the recommended image frame determined by the selection operation on the target recommended image frame to obtain the third input data.

16. An electronic device comprising:
one or more processors; and
one or more memories coupled to the one or more processors and storing a plurality of computer instructions that, when being executed, cause the one or more processors to:
process first input data into second input data in response to obtaining a first processing instruction for the first input data by using an AI processing model or an AI model service corresponding to the first processing instruction, the first input data being data input to a target application;
generate third input data based on an obtained adjustment operation for the second input data; and
generate a target file matching a user intent based on the user intent represented by the third input data.

17. The electronic device of claim 16, wherein the one or more first processors are further configured to:
generate the first processing instruction in response to obtaining a trigger operation of a first type of control acting on a first type of application, the first type of application being an application capable of responding to the first input data;
generate the first processing instruction in response to obtaining the trigger operation for the first input data input to a second type of application, the second type of application being an application configured to or configured not to respond to the first input data;
generate a corresponding first processing instruction based on application information of the third input data in response to obtaining the first input data input to a third type of application; and
generate the corresponding first processing instruction based on a type of the first input data and/or the application information of a source application.

18. The electronic device of claim 16, the one or more first processors are further configured to:
process the first input data into fourth input data based on the type of the first input data, and generating and processing first target data in the fourth input data to obtain the second input data; and
integrate and process the first input data input to the target application and its context data to obtain the second input data.

19. The electronic device of claim 16, wherein the one or more first processors are further configured to:
generate the third input data based on an obtained selection operation of recommended data for second target data in the second input data and/or an editing operation for the second target data;
generate the third input data based on an obtained configuration operation for a configuration option in a configuration window for the second input data, the configuration option being used to update the target data in the second input data; and
obtain context data associated with the second input data, and use the context data to update the second input data to generate the third input data.

20. The electronic device of claim 16, wherein the one or more first processors are further configured to:
generate a second processing instruction based on attribute information of the target application and/or the user intent represent by the third input data; and
generate the third input data using an AI processing model or an AI model service corresponding to the second processing instruction to obtain the target file matching the attribute information and the user intent.
